(19) United States
(12) Patent Application Publication
(10) Pub. No.: US 2021/0345466 A1
(43) Pub. Date: Nov. 4, 2021

(54) MATRIX LIGHT SOURCE WITH DIMMING

(71) Applicant: VALEO VISION, Bobigny Cedex (FR)

(72) Inventors: Zdravko ZOJCESKI, Bobigny Cedex (FR); Samuel DAROUSSIN, Bobigny Cedex (FR)

(73) Assignee: VALEO VISION, Bobigny Cedex (FR)

(21) Appl. No.: 17/280,559

(22) PCT Filed: Sep. 25, 2019
(86) PCT No.: PCT/EP2019/075838

§ 371 Date: Mar. 26, 2021

(30) Foreign Application Priority Data
Sep. 28, 2018 (FR) 18 59027

(51) Int. Cl. H05B 45/44; H05B 45/10

(52) U.S. Cl. CPC H05B 45/44; H05B 45/10

(57) ABSTRACT

The invention proposes a matrix light source having a plurality of elementary light sources with light-emitting semiconductor elements, and a common substrate in contact with an integrated circuit. The integrated circuit allows a brightness setpoint to be stored for each elementary light source of the matrix source, and comprises a circuit for managing the power supply for each source, allowing the brightness setpoint to be implemented without needing other external controls.

The invention relates to electroluminescent semiconductor element-based matrix light sources, in particular for motor vehicles. The invention relates in particular to a matrix light source with dimming of the emitted brightness.

A light-emitting diode (LED) is a semiconductor electronic component capable of emitting light when an electric current flows therethrough. In the automotive field, LED technology is increasingly being used for numerous light signaling solutions. LEDs are used to provide lighting functions such as daytime running lights, signaling lights, etc. The brightness emitted by an LED is generally dependent on the intensity of the electric current flowing therethrough. Inter alia, an LED is characterized by an electric current intensity threshold value. This maximum forward current generally decreases with increasing temperature. Likewise, when an LED emits light, a voltage drop equal to its forward voltage or nominal voltage is observed across its terminals. By driving the supply of electric power to a light-emitting diode so as to vary the average intensity of the electric current flowing therethrough, it is possible to dim the brightness (“dimming”) of the LED.

The use of matrix arrays of LEDs comprising a high number of elementary electroluminescent light sources is beneficial in numerous fields of application, and in particular also in the field of lighting and signaling for motor vehicles. A matrix array of LEDs may be used for example to create light beam forms that are beneficial for lighting functions, such as headlights or daytime running lights. In addition, a plurality of different lighting functions may be produced using a single matrix array, thus reducing the physical bulk in the restricted space of a motor vehicle headlight.

As is known, matrix light sources or, equivalently, pixelated light sources are controlled by a control unit that is physically remote from and electrically connected to the light source. The principle of dimming the brightness of an LED obviously does not extend to a matrix light source comprising a large number of pixels. The control unit should drive the electric current for each pixel, entailing at least one wired electrical connection per pixel. This solution is not particularly realistic, especially in the field of motor vehicle signaling, for which the volume available to produce a lighting module is limited.

One aim of the invention is to overcome at least one of the problems posed by the prior art. More precisely, the aim of the invention is to propose a matrix light source that makes it possible to dim the brightness emitted by each elementary light source that makes up its matrix array.

According to a first aspect of the invention, what is proposed is a matrix light source comprising an integrated circuit and a matrix array of electroluminescent semiconductor element-based elementary light sources. The matrix light source is noteworthy in that the integrated circuit is in contact with the matrix array and comprises, for at least two of the elementary light sources, a first memory element for storing a brightness setpoint to be produced by said elementary light source, the setpoint corresponding to a brightness that is between the minimum and maximum brightness able to be produced by said elementary light source, and a circuit for managing the supply of electric power to said elementary light source, configured so as to adapt the average intensity of the electric current flowing through said elementary light source such that the apparent brightness thereof complies with said setpoint.

According to another aspect of the invention, what is proposed is an integrated circuit for a matrix light source. The integrated circuit is intended to be in mechanical and electrical contact with a matrix array of elementary light sources of the matrix light source. The integrated circuit is noteworthy in that it comprises, for at least two of the elementary light sources, a first memory element for storing a brightness setpoint to be produced by said elementary light source, the setpoint corresponding to a brightness that is between the minimum and maximum brightness able to be produced by said elementary light source, and a circuit for managing the supply of electric power to said elementary light source, configured so as to adapt the average intensity of the electric current flowing through said elementary light source such that the apparent brightness thereof complies with said setpoint.

The matrix array of elementary light sources may preferably comprise a common substrate supporting the elementary light sources. The common substrate of the matrix may preferably comprise SiC.

Each light source may preferably be associated with its memory element and its electric power supply management circuit, the memory elements and the management circuits associated with different elementary light sources being independent of one another.

The integrated circuit may preferably comprise an Si substrate. The integrated circuit is preferably soldered or adhesively bonded to the matrix array of elementary light sources, for example to a common substrate supporting the elementary light sources. The integrated circuit is preferably soldered or adhesively bonded to the lower face of the common substrate, opposite the face that comprises the elementary light sources. The integrated circuit is preferably in mechanical contact, for example via fastening means, and in electrical contact with the common substrate, which has electrical connection areas on its lower face.

The integrated circuit may preferably comprise a dedicated memory element and a dedicated electric power supply management circuit for each of the elementary light sources.

The electric power supply management circuit may preferably comprise a switch element for selectively supplying electricity to said elementary light source, and a circuit for generating a binary pulse width-modulated control signal, the signal serving as a control mechanism for the switch element.

The duty cycle and/or the amplitude of the control signal may preferably depend on the brightness setpoint.

The management circuit may preferably be configured so as to calculate the duty cycle of the control signal so as to correspond to a quantized value between 0 and 1, reflecting the value of the brightness setpoint to be produced by said elementary light source, the setpoint corresponding to a brightness that is between the minimum and maximum brightness.

The substrate may preferably furthermore comprise, for at least one of the elementary light sources, a circuit for detecting a short circuit and/or a circuit for detecting an open circuit fault with said elementary light source and/or a unit for delaying the activation of the elementary light source.

The integrated circuit may preferably furthermore comprise at least one second memory element for recording information on the detection of a short circuit and/or an open circuit fault with said elementary light source and/or on an activation delay period.

According to another aspect of the invention, what is proposed is a lighting module. The module comprises a control unit, a matrix light source and a circuit for driving the supply of electric power to said source. The lighting module is noteworthy in that the control unit is configured so as to transmit a brightness setpoint for each elementary light source of the matrix light source to same, in that the matrix light source is in accordance with one aspect of the invention, and in that said brightness setpoints are recorded respectively in the memory elements associated with each of the elementary light sources.

Said lighting module may preferably be a lighting module for a motor vehicle. As an alternative, it may be a module for projecting or displaying shaded images, such as for example a screen. Each shade corresponds to a predetermined brightness setpoint of a pixel/of an elementary light source of the matrix array of sources.

According to yet another aspect of the invention, what is proposed is a method for projecting a shaded image by way of a matrix light source according to one of the aspects of the invention. The method is noteworthy in that it comprises the following steps:
providing a shaded digital image in a control unit, the dimensions in pixels of the image corresponding to the dimensions of the matrix source;
by way of the control unit, generating a brightness setpoint for each elementary light source of the matrix light source and transmitting same thereto, the brightness setpoint for a given elementary light source being representative of the shade of the corresponding pixel of the digital image;
in the matrix source, recording the received corresponding brightness setpoint in the memory elements associated with each of the elementary light sources;
by way of the matrix source, emitting, for each of the elementary light sources, a light beam whose apparent brightness complies with the received corresponding brightness setpoint.

The pixelated light source, or equivalently, the matrix light source, may preferably comprise at least one matrix array of electroluminescent elements—the elementary light sources, also called monolithic array, being arranged in at least two columns by at least two rows. The electroluminescent source preferably comprises at least one monolithic matrix array of electroluminescent elements, also called a monolithic matrix array.

In a monolithic matrix array, the electroluminescent elements are grown from a common substrate and are electrically connected so as to be able to be activated selectively, individually or by subset of electroluminescent elements. Each electroluminescent element or group of electroluminescent elements may thus form one of the elementary emitters of said pixelated light source that is able to emit light when its or their material is supplied with electricity.

Various arrangements of electroluminescent elements may meet this definition of a monolithic matrix array, provided that the electroluminescent elements have one of their main dimensions of elongation substantially perpendicular to a common substrate and that the spacing between the elementary emitters, formed by one or more electroluminescent elements grouped together electrically, is small in comparison with the spacings that are imposed in known arrangements of flat square chips soldered to a printed circuit board.

The substrate may be made predominantly of semiconductor material. The substrate may comprise one or more further materials, for example non-semiconductor materials. These electroluminescent elements, of submillimeter dimensions, are for example arranged so as to project from the substrate so as to form rods of hexagonal cross section. The electroluminescent rods originate on a first face of a substrate. Each electroluminescent rod, formed in this case using gallium nitride (GaN), extends perpendicularly, or substantially perpendicularly, projecting from the substrate, in this case produced from silicon, with other materials, such as silicon carbide, being able to be used without departing from the context of the invention. By way of example, the electroluminescent rods could be produced from an alloy of aluminum nitride and of gallium nitride (AlGaN), or from an alloy of aluminum, indium and gallium phosphors (AlInGaP). Each electroluminescent rod extends along a longitudinal axis defining its height, the base of each rod being arranged in a plane of the upper face of the substrate.

The electroluminescent rods of one and the same monolithic matrix array advantageously have the same shape and the same dimensions. They are each delimited by an end face and by a circumferential wall that extends along the axis of elongation of the rod. When the electroluminescent rods are doped and subjected to polarization, the resulting light at the output of the semiconductor source is emitted mainly from the circumferential wall, it being understood that light rays may also exit from the end face. The result of this is that each electroluminescent rod acts as a single light-emitting diode and that the light output of this source is improved firstly by the density of the electroluminescent rods that are present and secondly by the size of the lighting surface defined by the circumferential wall and that therefore extends over the entire perimeter and the entire height of the rod. The height of a rod may be between 2 and 10 μm, preferably 8 μm. The largest dimension of the end face of a rod is less than 2 μm, preferably less than or equal to 1 μm.

It is understood that, when forming the electroluminescent rods, the height may be modified from one area of the pixelated light source to another in such a way as to boost the luminance of the corresponding area when the average height of the rods forming it is increased. Thus, a group of electroluminescent rods may have a height, or heights, that are different from another group of electroluminescent rods, these two groups forming the same semiconductor light source comprising electroluminescent rods of submillimeter dimensions. The shape of the electroluminescent rods may also vary from one monolithic matrix array to another, in particular over the cross section of the rods and over the shape of the end face. The rods have a generally cylindrical shape, and they may in particular have a polygonal and more particularly hexagonal cross section. It is understood that it is important, for light to be able to be emitted through the circumferential wall, that the latter has a polygonal or circular shape.

Moreover, the end face may have a shape that is substantially planar and perpendicular to the circumferential wall, such that it extends substantially parallel to the upper face of the substrate, or else it may have a shape that is curved or pointed at its center, so as to increase the directions in which the light exiting from this end face is emitted.

The electroluminescent rods may preferably be arranged in a two-dimensional matrix array. This arrangement could be such that the rods are arranged in a quincunx. Generally speaking, the rods are arranged at regular intervals on the substrate and the distance separating two immediately adjacent electroluminescent rods, in each of the dimensions of the matrix array, should be at least equal to 2 μm, preferably between 3 μm and 10 μm, such that the light emitted through the circumferential wall of each rod is able to exit from the matrix array of electroluminescent rods. Provision is furthermore made for these separating distances, measured between two axes of elongation of adjacent rods, not to be greater than 100 μm.

As an alternative, the monolithic matrix array may comprise electroluminescent elements formed by layers of epitaxial electroluminescent elements, in particular a first layer of n-doped GaN and a second layer of p-doped GaN, on a single substrate, for example made of silicon carbide, and which is sliced (by grinding and/or ablation) to form a plurality of elementary emitters respectively originating from one and the same substrate. The result of such a design is a plurality of electroluminescent blocks all originating from one and the same substrate and electrically connected so as to be able to be activated selectively from one another.

In one exemplary embodiment according to this other embodiment, the substrate of the monolithic matrix array may have a thickness of between 5 μm and 800 μm, in particular equal to 200 μm; each block may have a length and a width, each being between 50 μm and 500 μm, preferably between 100 μm and 200 μm. In one variant, the length and the width are equal. The height of each block is less than 500 μm, preferably less than 300 μm. Finally, the exit surface of each block may be formed via the substrate on the side opposite the epitaxy. The separating distance between two elementary emitters. The distance between each contiguous elementary emitter may be less than 1 mm, in particular less than 500 μm, and is preferably less than 200 μm.

As an alternative, both with electroluminescent rods extending respectively projecting from one and the same substrate, as described above, and with electroluminescent blocks obtained by slicing electroluminescent layers superimposed on one and the same substrate, the monolithic matrix array may furthermore comprise a layer of a polymer material in which the electroluminescent elements are at least partially embedded. The layer may thus extend over the entire extent of the substrate, or only around a given group of electroluminescent elements. The polymer material, which may in particular be silicone-based, creates a protective layer that makes it possible to protect the electroluminescent elements without impairing the diffusion of the light rays. Furthermore, it is possible to integrate, into this layer of polymer material, wavelength conversion means, for example luminophores, that are able to absorb at least some of the rays emitted by one of the elements and to convert at least some of said absorbed excitation light into an emission light having a wavelength that is different from that of the excitation light. Provision may be made without distinction for the luminophores to be embedded in the mass of the polymer material, or else to be arranged on the surface of the layer of this polymer material.

The pixelated light source may furthermore comprise a coating of reflective material to deflect the light rays to the exit surfaces of the light source.

The electroluminescent elements of submillimeter dimensions define a given exit surface in a plane substantially parallel to the substrate. It will be understood that the shape of this exit surface is defined as a function of the number and the arrangement of the electroluminescent elements that form it. It is thus possible to define a substantially rectangular shape of the emission surface, it being understood that the latter may vary and adopt any shape without departing from the context of the invention.

Using the measures proposed by the present invention, it becomes possible to provide a matrix light source or pixelated light source that makes it possible to dim the brightness emitted by each elementary light source that makes up its matrix array. The matrix light source according to some aspects of the invention comprises an integrated circuit that houses, potentially for each elementary light source, a memory element for recording therein a value that corresponds to a brightness setpoint, and a circuit for managing the supply of electric power to the elementary light source. The electric power supply management circuit adapts the average intensity of the electric current, for example by way of a pulse width modulation (PWM) control signal for the elementary light source in question. The brightness emitted by each pixel is thus dimmed by the matrix source itself. The brightness setpoint is the only external command that the circuit for managing the supply of electric power to the elementary light source needs to control the elementary source. It therefore becomes possible to transmit a set of brightness setpoints—equivalently: a shaded digital image—to the matrix source. The setpoint value for each pixel is recorded in the integrated circuit, which takes responsibility for producing same. A new setpoint is necessary only if the brightness to be emitted by one of the pixels changes. The pixels whose brightness to be emitted is constant do not need to receive continuous instructions. The invention is applicable in the field of motor vehicle signaling, for which the formation of light beams having particular shapes and dimming of brightnesses is made easier. The invention is however also applicable to screens produced with matrix arrays of light-emitting diodes, or to image projectors produced with matrix arrays of light-emitting diodes. When the invention is applied to a screen or to a projector in particular, it is interesting to note that the volume of data transmitted from a control unit to the matrix light source is limited: for one image, at most one complete set of setpoint values needs to be transmitted once to the matrix light source. When only part of the image changes with respect to a previous image, only the setpoints for the pixels modified by the new image need to be transmitted to the matrix light source.

Other features and advantages of the present invention will be better understood with the aid of the description of the examples and of the drawings, in which:

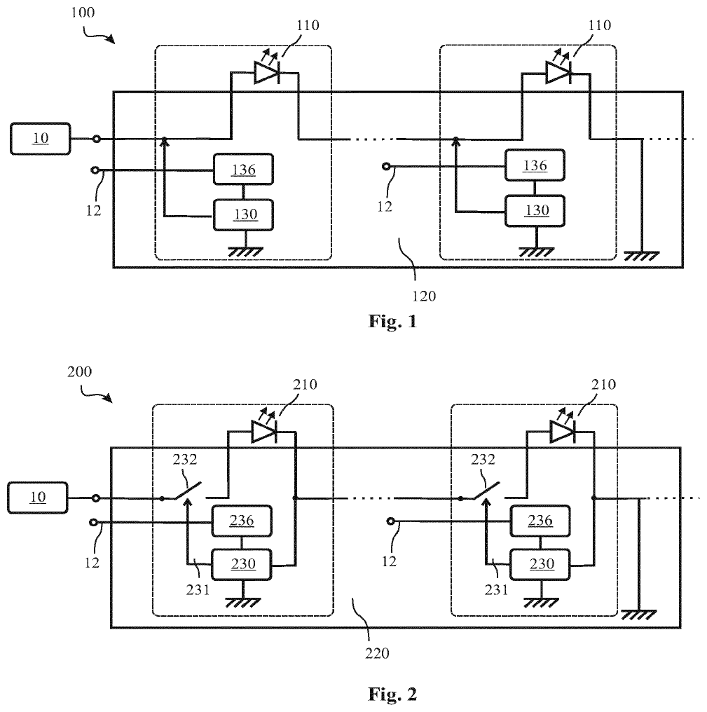

FIG. 1 schematically shows a matrix light source according to one preferred embodiment of the invention;

FIG. 2 schematically shows a matrix light source according to one preferred embodiment of the invention.

Unless specified otherwise, technical features that are described in detail for one given embodiment may be combined with the technical features that are described in the context of other embodiments described by way of example and without limitation. Similar reference numerals will be used to describe similar concepts across various embodiments of the invention. For example, the references 100 and 200 denote two embodiments of a matrix light source according to the invention.

The illustration in FIG. 1 shows a pixelated light source or matrix light source 100 according to one preferred embodiment of the invention. The matrix light source 100 comprises a plurality of electroluminescent semiconductor element-based elementary light sources 110 and a common substrate, not illustrated, in mechanical and electrical contact with and functionally connected to an integrated circuit 120. The elementary light sources are typically light-emitting diodes (LEDs).

The matrix light source 100 preferably comprises a monolithic matrix array component, in which the semiconductor layers of the elementary light sources 110 are for example arranged on the common substrate. The matrix array of elementary light sources 110 preferably comprises a parallel assembly of a plurality of branches, each branch comprising electroluminescent semiconductor light sources 110.

By way of example and without limitation, the matrix array of elementary light sources 100 comprises, along the thickness of the substrate and starting at the end opposite the location of the elementary sources 110, a first electrically conductive layer deposited on an electrically insulating substrate. This is followed by an n-doped semiconductor layer whose thickness is between 0.1 and 2 μm. This thickness is much smaller than that of known light-emitting diodes, for which the corresponding layer has a thickness of the order of 1 to 2 μm. The following layer is the active quantum well layer having a thickness of around 30 nm, followed by an electron-blocking layer, and finally a p-doped semiconductor layer, the latter having a thickness of around 300 nm. Preferably, the first layer is an (Al)GaN:Si layer, the second layer is an n-GaN:Si layer, and the active layer comprises quantum wells made of InGaN alternating with barriers made of GaN. The blocking layer is preferably made of AlGaN:Mg and the p-doped layer is preferably made of p-GaN:Mg. n-Doped gallium nitride has a resistivity of 0.0005 ohm/cm, whereas p-doped gallium nitride has a resistivity of 1 ohm/cm. The thicknesses of the proposed layers make it possible in particular to increase the internal series resistance of the elementary source, while at the same time significantly reducing its manufacturing time, as the n-doped layer is not as thick in comparison with known LEDs and requires a shorter deposition time. By way of example, a time of 5 hours is typically required for MOCVD depositions for a standard-configuration LED with 2μ of n layer, and this time may be reduced by 50% if the thickness of the n layer is reduced to 0.2μ.

In order to achieve elementary light sources 110 having semiconductor layers having homogeneous thicknesses, the monolithic component 100 is preferably manufactured by depositing the layers homogeneously and uniformly over at least part of the surface of the substrate so as to cover it. The layers are deposited for example using a metal oxide chemical vapor deposition (MOCVD) method. Such methods and reactors for implementing them are known for depositing semiconductor layers on a substrate, for example from patent documents WO 2010/072380 A1 or WO 01/46498 A1. Details on their implementation will therefore not be described in the context of the present invention. The layers thus formed are then pixelated. By way of example and without limitation, the layers are removed using known lithographic methods and by etching at the sites that subsequently correspond to the spaces between the elementary light sources 110 on the substrate. A plurality of several tens or hundreds or thousands of pixels 110 having a surface area smaller than one square millimeter for each individual pixel, and having a total surface area greater than 2 square millimeters, having semiconductor layers with homogeneous thicknesses, and therefore having homogeneous and high internal series resistances, are thus able to be produced on the substrate of a matrix light source 100. Generally speaking, the more the size of each LED pixel decreases, the more its series resistance increases, and the more this pixel is able to be driven by a voltage source. As an alternative, the substrate comprising the deposited layers covering at least part of the surface of the substrate is sawn or divided into elementary light sources, each of the elementary light sources having similar characteristics in terms of their internal series resistance.

The invention also relates to types of semiconductor element-based elementary light sources involving other configurations of semiconductor layers. In particular the substrates, the semiconductor materials of the layers, the arrangement of the layers, their thicknesses and any vias between the layers may be different from the example that has just been described.

The integrated circuit 120 is preferably soldered to the lower face of the common substrate, which houses the elementary light sources on its upper face, so as to establish mechanical and electrical contact with the substrate and the elementary light sources. The integrated circuit furthermore comprises, for at least two but preferably for all the elementary light sources 110, a dedicated memory element or register 136, formed for example by flip-flop electronic circuits, for storing therein a brightness setpoint to be produced by the elementary light source 110. The setpoint 12 corresponds to a degree of brightness that is between the minimum and maximum brightness able to be produced by said elementary light source. The integrated circuit 120 also comprises an electronic circuit 130 for managing the supply of electric power to the elementary light source in question. The circuit 130 is configured so as to adapt the average intensity of the electric current flowing through the elementary light source 110 so that the apparent brightness thereof complies with said setpoint.

Using an integrated circuit 120 in mechanical and electrical contact with the substrate on which the elementary light sources reside makes it possible to dispense with wired connections, the number of which would be at least equal to the number of pixels of the matrix light source.

Preferably, a power supply circuit may be integrated into the substrate when the monolithic component 100 is manufactured.

The illustration in FIG. 2 shows a pixelated light source or matrix light source 200 according to one preferred embodiment of the invention. The matrix light source 200 comprises a plurality of electroluminescent semiconductor element-based elementary light sources 210 and a common substrate, not illustrated, in contact with and functionally connected to an integrated circuit 220. The elementary light sources are typically light-emitting diodes (LEDs).

The integrated circuit 220 is preferably soldered to the lower face of the common substrate, which houses the elementary light sources on its upper face, so as to establish mechanical and electrical contact with the substrate and the elementary light sources. The integrated circuit furthermore comprises, for at least two but preferably for all the elementary light sources 210, a memory element or register 236, formed for example by flip-flop electronic circuits, for storing therein a brightness setpoint to be produced by the elementary light source 210. The setpoint 12 corresponds to a degree of brightness that is between the minimum and maximum brightness able to be produced by said elementary light source. The integrated circuit 220 also comprises an electronic circuit 230 for managing the supply of electric power to the elementary light source. The circuit 230 is configured so as to adapt the average intensity of the electric current flowing through the elementary light source 210 so that the apparent brightness thereof complies with said setpoint.

The matrix light source 200 illustrated for this embodiment is intended to be driven in terms of voltage by a drive circuit for the electric power supply 10. Such circuits are known per se in the art, and their operation will not be described in detail in the context of the present invention. They involve at least one converter circuit capable of converting an input voltage, supplied for example by a voltage source internal to a motor vehicle, such as a battery, into an output voltage, having an intensity suitable for supplying power to the matrix light source. When the matrix light source is driven in terms of voltage, the driving of each elementary source, or equivalently, of each pixel, merely entails controlling a switch device 232 as shown schematically in FIG. 2. By controlling the state of the device 232, the elementary light source 210 may be selectively connected to the voltage source 10. The switch device is for example formed by a MOSFET field-effect transistor, preferably characterized by a low voltage drop between its drain and source terminals, and controlled by a control signal 231 from the power supply management circuit 230. The control signal 231 is preferably a pulse width modulation (PWM) signal. This is a cyclic binary signal. The choice of the duty cycle, that is to say the respective duration of the non-zero phase and of the zero phase of the cycle, directly influences the average value of the signal, which is between the extreme values of the signal. The cyclic signal 231 forms a sequence of binary commands for opening/closing the switch device 232. The average intensity of the electric current flowing through the elementary light source 210, and therefore the average brightness emitted by this elementary light source, reflects the average value of the PWM control signal 231.

The power supply management circuit 230 comprises a circuit for generating a PWM signal, configured so that the generated signal has an average value that reflects the brightness setpoint 12 stored in the memory element 236. For example, for a maximum brightness level, the duty cycle is set to the value 1: the switch 232 remains in its closed state and the light source 210 is supplied with power continuously. For intermediate brightness levels between the zero value and the maximum brightness, the duty cycle of the PWM signal, that is to say the ratio between the total duration of the “on” phase during one cycle, and the total duration of the cycle, is chosen so as to correspond substantially to a quantization between 0 and 1 of the brightness setpoint 12. By way of example, for a setpoint that may adopt 256 different values, the setpoint 128 will be quantized by a quantization unit at the value 0.5. This will therefore correspond to a control signal 231 having a duty cycle equivalent to 0.5. Electronic circuits capable of generating parameterized PWM signals are known per se in the art, and their operation will not be described in detail in the context of the present invention. Depending on the voltage level required to control the state of the transistor 232, the management circuit 230 furthermore comprises a circuit for raising the level of the signal 231 (“level shifter”), which makes it possible to adapt the maximum amplitude of the binary PWM signal 231 to the required voltage level.

In all of the embodiments, the integrated circuit preferably comprises a unit for receiving the signal 12, which makes it possible to extract the brightness setpoint therefrom and to record it in the memory clement 136, 236.

It goes without saying that the integrated circuit may comprise other electronic circuits and/or memory elements used for other functions in connection with the matrix light source and/or with the elementary light sources. This includes but is not limited to circuits for detecting a short circuit or an open circuit fault with an elementary light source.

All of the embodiments arc applicable for example in the projection of a shaded image. A projection method comprises the following steps:
providing a shaded digital image in a control unit, the dimensions in pixels of the image corresponding to the dimensions of the matrix source;
by way of the control unit, generating a brightness setpoint for each elementary light source of the matrix light source and transmitting same thereto, the brightness setpoint for a given elementary light source being representative of the shade of the corresponding pixel of the digital image;
in the matrix source, recording the received corresponding brightness setpoint in the memory elements associated with each of the elementary light sources;
by way of the matrix source, emitting, for each of the elementary light sources, a light beam whose apparent brightness complies with the received corresponding brightness setpoint.

The scope of protection is defined by the claims.

1. A matrix light source comprising an integrated circuit and a matrix array of electroluminescent semiconductor element-based elementary light sources, wherein
the integrated circuit is in contact with the matrix array and comprises, for at least two of the elementary light sources,
a memory element for storing a brightness setpoint to be produced by said elementary light source, the setpoint corresponding to a brightness that is between the minimum and maximum brightness able to be produced by said elementary light source, and
a circuit for managing the supply of electric power to said elementary light source, configured so as to adapt the average intensity of the electric current flowing through said elementary light source such that the apparent brightness thereof complies with said setpoint.

2. The light source as claimed in claim 1, wherein the integrated circuit comprises a dedicated memory element and a dedicated electric power supply management circuit for each of the elementary light sources.

3. The light source as claimed in claim 1, wherein the electric power supply management circuit comprises a switch element for selectively supplying electricity to said elementary light source, and a circuit for generating a binary pulse width-modulated control signal, the signal serving as a control mechanism for the switch element.

4. The light source as claimed in claim 3, wherein the duty cycle and/or the amplitude of the control signal depends on the brightness setpoint.

5. The light source as claimed in claim 4, wherein the management circuit is configured so as to calculate the duty cycle of the control signal so as to correspond to a quantized value between 0 and 1, reflecting the value of the brightness setpoint to be produced by said elementary light source, the setpoint corresponding to a brightness that is between the minimum and maximum brightness.

6. A lighting module comprising a control unit, a matrix light source and a circuit for driving the supply of electric power to said source, wherein the control unit is configured so as to transmit a brightness setpoint for each elementary light source of the matrix light source to same, in that the matrix light source is as claimed in claim 1, and in that said brightness setpoints are recorded respectively in the memory elements associated with each of the elementary light sources.

7. The lighting module as claimed in claim 6, wherein it is a lighting module for a motor vehicle.

8. A method for projecting a shaded image by way of a matrix light source as claimed in claim 1, wherein the method comprises the following steps:
providing a shaded digital image in a control unit, the dimensions in pixels of the image corresponding to the dimensions of the matrix source;
by way of the control unit, generating a brightness setpoint for each elementary light source of the matrix light source and transmitting same thereto, the brightness setpoint for a given elementary light source being representative of the shade of the corresponding pixel of the digital image;
in the matrix source, recording the received corresponding brightness setpoint in the memory elements associated with each of the elementary light sources;
by way of the matrix source, emitting, for each of the elementary light sources, a light beam whose apparent brightness complies with the received corresponding brightness setpoint.

9. The light source as claimed in claim 2, wherein the electric power supply management circuit comprises a switch element for selectively supplying electricity to said elementary light source, and a circuit for generating a binary pulse width-modulated control signal, the signal serving as a control mechanism for the switch element.

10. The light source as claimed in claim 9, wherein the duty cycle and/or the amplitude of the control signal depends on the brightness setpoint.

11. The light source as claimed in claim 10, wherein the management circuit is configured so as to calculate the duty cycle of the control signal so as to correspond to a quantized value between 0 and 1, reflecting the value of the brightness setpoint to be produced by said elementary light source, the setpoint corresponding to a brightness that is between the minimum and maximum brightness.

12. A lighting module comprising a control unit, a matrix light source and a circuit for driving the supply of electric power to said source, wherein the control unit is configured so as to transmit a brightness setpoint for each elementary light source of the matrix light source to same, in that the matrix light source is as claimed in claim 2, and in that said brightness setpoints are recorded respectively in the memory elements associated with each of the elementary light sources.

13. The lighting module as claimed in claim 12, wherein it is a lighting module for a motor vehicle.

14. A lighting module comprising a control unit, a matrix light source and a circuit for driving the supply of electric power to said source, wherein the control unit is configured so as to transmit a brightness setpoint for each elementary light source of the matrix light source to same, in that the matrix light source is as claimed in claim 3, and in that said brightness setpoints are recorded respectively in the memory elements associated with each of the elementary light sources.

15. The lighting module as claimed in claim 14, wherein it is a lighting module for a motor vehicle.

16. A lighting module comprising a control unit, a matrix light source and a circuit for driving the supply of electric power to said source, wherein the control unit is configured so as to transmit a brightness setpoint for each elementary light source of the matrix light source to same, in that the matrix light source is as claimed in claim 4, and in that said brightness setpoints are recorded respectively in the memory elements associated with each of the elementary light sources.

17. The lighting module as claimed in claim 16, wherein it is a lighting module for a motor vehicle.

18. A method for projecting a shaded image by way of a matrix light source as claimed in claim 2, wherein the method comprises the following steps:
providing a shaded digital image in a control unit, the dimensions in pixels of the image corresponding to the dimensions of the matrix source;
by way of the control unit, generating a brightness setpoint for each elementary light source of the matrix light source and transmitting same thereto, the brightness setpoint for a given elementary light source being representative of the shade of the corresponding pixel of the digital image;
in the matrix source, recording the received corresponding brightness setpoint in the memory elements associated with each of the elementary light sources;
by way of the matrix source, emitting, for each of the elementary light sources, a light beam whose apparent brightness complies with the received corresponding brightness setpoint.

19. A method for projecting a shaded image by way of a matrix light source as claimed in claim 3, wherein the method comprises the following steps:
providing a shaded digital image in a control unit, the dimensions in pixels of the image corresponding to the dimensions of the matrix source;
by way of the control unit, generating a brightness setpoint for each elementary light source of the matrix light source and transmitting same thereto, the brightness setpoint for a given elementary light source being representative of the shade of the corresponding pixel of the digital image;
in the matrix source, recording the received corresponding brightness setpoint in the memory elements associated with each of the elementary light sources;
by way of the matrix source, emitting, for each of the elementary light sources, a light beam whose apparent brightness complies with the received corresponding brightness setpoint.

20. A method for projecting a shaded image by way of a matrix light source as claimed in claim 4, wherein the method comprises the following steps:
providing a shaded digital image in a control unit, the dimensions in pixels of the image corresponding to the dimensions of the matrix source;
by way of the control unit, generating a brightness setpoint for each elementary light source of the matrix light source and transmitting same thereto, the brightness setpoint for a given elementary light source being representative of the shade of the corresponding pixel of the digital image;
in the matrix source, recording the received corresponding brightness setpoint in the memory elements associated with each of the elementary light sources;
by way of the matrix source, emitting, for each of the elementary light sources, a light beam whose apparent brightness complies with the received corresponding brightness setpoint.
